(19) United States
(12) Patent Application Publication
(10) Pub. No.: US 2025/0186905 A1
(43) Pub. Date: Jun. 12, 2025

(54) METHOD FOR MANUFACTURING OIL-WATER SEPARATOR BY USING 3D PRINTING PROCESS, AND OIL-WATER SEPARATOR AND OIL-WATER SEPARATION SYSTEM MANUFACTURED THEREBY

(71) Applicant: IUCF-HYU (INDUSTRY-UNIVERSITY COOPERATION FOUNDATION HANYANG UNIVERSITY), Seoul (KR)

(72) Inventors: Sang Yeun PARK, Seoul (KR); Hong Yun SO, Seoul (KR); Jae Bum SUNG, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 18/845,556

(22) PCT Filed: Oct. 24, 2022
(86) PCT No.: PCT/KR2022/016262

§ 371 Date: Sep. 10, 2024

(30) Foreign Application Priority Data
Mar. 11, 2022 (KR) 10-2022-0030444

(51) Int. Cl. B01D 17/02; B01D 17/12; B29C 33/42; B29C 39/02; B29C 39/26; B29L 31/00

(52) U.S. Cl. CPC B01D 17/02; B01D 17/12; B29C 33/424; B29C 39/026; B29C 39/26; B01D 2257/80; B29K 2995/0092; B29K 2995/0093; B29L 2031/00

(57) ABSTRACT

Provided is a method for manufacturing an oil-water separator. The method for manufacturing an oil-water separator may comprise the steps of: preparing a mold including a bottom portion, a side wall portion on the edge of the bottom portion, and a pattern portion on the central region of the bottom portion; and providing a polymer in the mold and curing the polymer to prepare an oil-water separator, wherein the pattern portion has a height higher than that of the side wall portion, on the basis of the bottom portion, and has a cross-sectional area tapering away from the bottom portion.

### TECHNICAL FIELD

The present application relates to a method for manufacturing an oil-water separator, and an oil-water separator and an oil-water separation system manufactured thereby, and more specifically, to a method for manufacturing an oil-water separator using a 3D printing process, and an oil-water separator and an oil-water separation system manufactured thereby.

### BACKGROUND ART

The recent oil spill accident can be said to be an accident that causes oil to flow from a damaged ship to pollute the nearby sea, and among accidents that occur in the sea, it causes severe damage to the environment. In case of the oil spill accident that occurs in the sea, rapid removal of oil is required because the oil is not stagnant and spreads widely at a rapid pace.

As a method for removing the spilled oil, there are oil recovery ships for removing the spilled oil using an adsorbent and a skimmer after installing an oil fence, or sucking the spilled oil into the ship using the ship, separating oil and water, and discharging the water again to the outside, and there is a trend that demand and interest in related fields are increasing in order to cope with continuously occurring marine accidents.

In particular, oil-water separators used in oil-water recovery ships have to be used continuously at the sea, and thus the blockage of strong waves and seawater foreign substances at sea has to be solved, and the most important part of the oil-water separator is maintaining the performance of the oil-water separator through continuous washing.

In order to solve the above problems, recently, technical studies on oil-water separators using nano or micro structures have been actively conducted.

Conventionally used oil-water separators are designed and manufactured by various methods such as deposition, photo etching, plating, and oxidation processes to secure excellent performance in chemical resistance, corrosion resistance, and clogging.

However, there is a problem in that it takes a long time to manufacture the oil-water separator upon expansion to a large area, and a unit price of the oil-water separator is high, and thus it is necessary to develop an oil-water separator having high productivity and stable oil-water separation efficiency.

In order to solve the problems, the present application is to disclose a method for manufacturing an oil-water separator, which has improved productivity and stable oil-water separation efficiency by manufacturing the oil-water separator using a 3D printer and utilizing the same in an oil-water separation system, and an oil-water separator and an oil-water separation system manufactured thereby.

### DISCLOSURE

### Technical Problem

One technical problem to be solved by the present application is to provide a method for manufacturing an oil-water separator using a 3D printing process, and an oil-water separator and an oil-water separation system manufactured thereby.

Another technical problem to be solved by the present application is to provide a method for manufacturing an oil-water separator having improved oil-water separation efficiency, and an oil-water separator and an oil-water separation system manufactured thereby.

Still another technical problem to be solved by the present application is to provide a method for manufacturing an oil-water separator having improved productivity, and an oil-water separator and an oil-water separation system manufactured thereby.

The technical problems to be solved by the present application are not limited to those described above.

### Technical Solution

In order to solve the above technical problems, the present application provides a method for manufacturing an oil-water separator.

According to one embodiment, the method for manufacturing an oil-water separator may include: preparing a mold including a bottom portion, a side wall portion provided on an edge of the bottom portion, and a pattern portion provide on a central region of the bottom portion; and providing a polymer in the mold and curing the polymer to manufacture the oil-water separator, in which the pattern portion may have a height higher than a height of the side wall portion based on the bottom portion, and may have a cross-sectional area that becomes narrow in a direction away from the bottom portion.

According to one embodiment, the mold may include: a plurality of first convex portions provided on surfaces of the bottom portion, the side wall portion, and the pattern portion, and being parallel to each other; and a plurality of first concave portions defined between adjacent first convex portions.

According to one embodiment, the mold may be manufactured using a 3D printing process employing fused filament fabrication.

According to one embodiment, the pattern portion may include a first inclined surface inclined to the bottom portion, and the plurality of first convex portions may be spaced apart from each other in an extension direction of the first inclined surface.

According to one embodiment, the method for manufacturing an oil-water separator may further include hydrophilizing a surface of the oil-water separator after the manufacturing of the oil-water separator.

According to one embodiment, the first inclined surface of the pattern portion may form an angle of 20° to 40° with respect to the bottom portion.

To solve the above technical problems, the present application provides an oil-water separator manufactured using a 3D printed mold.

According to one embodiment, the oil-water separator may include: a base material including a first surface and a second surface facing the first surface; and a plurality of oil-water separation holes formed through the base material, in which a first opening of the oil-water separation hole formed in the first surface may be larger than a second opening of the oil-water separation hole formed in the second surface.

According to one embodiment, the oil-water separator may have hydrophobicity and lipophilicity, and oil in oil-water supplied to the oil-water separator may pass through the oil-water separation hole, and water in the oil-water may flow down along the first surface.

According to one embodiment, the oil-water separator may have hydrophilicity and oil-repellency, and water in oil-water supplied to the oil-water separator may pass through the oil-water separation hole, and oil in the oil-water may flow down along the first surface.

According to one embodiment, the oil-water separator may include: a plurality of second concave portions provided on surfaces of the base material and the oil-water separation hole, and being parallel to each other; and a plurality of second convex portions defined by adjacent second concave portions, and oil-water supplied onto the oil-water separator may be guided to the oil-water separation hole along the second concave portion, and one of water and oil may be discharged through the oil-water separation hole.

According to one embodiment, the oil-water separation hole may include a second inclined surface inclined to the first surface as a side wall, and the plurality of second concave portions may be spaced apart from each other in an extension direction of the second inclined surface.

To solve the above technical problems, the present application provides an oil-water separation system manufactured using a 3D printed mold.

According to one embodiment, the oil-water separation system may include a support module configured to support the oil-water separator of claim 7 such that the oil-water separator is inclined, and a storage container configured to accommodate water and oil separated from each other, in which the support module may include: a first support configured to support one side of the oil-water separator into which oil-water is introduced; and a second support having a length shorter than a length of the first support, and configured to support the other side of the oil-water separator through which the oil-water is discharged after being separated from each other, and the storage container may include: a first container disposed between the first support and the second support to accommodate one of water and oil; and a second container disposed on a side of the second support to accommodate the other of water and oil.

According to one embodiment, the oil-water separation hole may include a second inclined surface inclined to the first surface as a side wall, the second inclined surface may be formed in a direction opposite to a flowing direction of the oil-water, so that one of water and oil may flow along the second inclined surface, and the other of water and oil may flow from the first support toward the second support along the first surface of the oil-water separator where the oil-water separation hole is not formed.

### Advantageous Effects

According to the method for manufacturing an oil-water separator according to the embodiment of the present application, it is possible to manufacture an oil-water separator by preparing a mold, providing a polymer in the mold, and curing the polymer. Accordingly, the oil-water separator may be manufactured in large quantities, manufacturing costs thereof may be reduced, and manufacturing time thereof may be shortened.

Further, the oil-water separator may include a base material and a plurality of oil-water separation holes formed through the base material, and may include a plurality of second concave portions formed on a surface of the base material having the oil-water separation hole. The oil-water supplied onto the oil-water separator may be guided to the oil-water separation hole along the second concave portion, one of water and oil may be discharged through the oil-water separation hole, and the other of water and oil may be collected while flowing down along the base material. Accordingly, it is possible to manufacture an oil-water separator having improved oil-water separation efficiency.

Further, an oil-water separation system may include: a support module configured to support the oil-water separator such that the oil-water separator is inclined; and a storage container configured to accommodate separated water and oil, in which the support module may include: a first support configured to support one side of the oil-water separator into which oil-water is introduced; and a second support having a length shorter than a length of the first support, and configured to support the other side of the oil-water separator through which the oil-water is discharged after being spaced apart from each other, and the storage container may include: a first container disposed between the first support and the second support to accommodate one of water and oil; and a second container disposed on a side of the second support to accommodate the other of water and oil. An inclination angle at which the oil-water separator is installed may be controlled by the first support and the second support, and thus a flowing rate of the oil-water supplied onto the oil-water separator may be controlled, thereby improving oil-water separation efficiency.

### DESCRIPTION OF DRAWINGS

FIG. 1 is a flowchart for explaining a method for manufacturing an oil-water separator according to an embodiment of the present application.

FIG. 2 is a view for explaining a mold used in the method for manufacturing an oil-water separator according to the embodiment of the present application.

FIG. 3 is a sectional view taken along line A-A′ of FIG. 2.

FIG. 4 is a for explaining a process of providing a polymer and a process of separating the oil-water separator from the mold.

FIG. 5 is a view for explaining the oil-water separator including an oil-water separation hole according to the embodiment of the present application.

FIG. 6 is a sectional view taken along line B-B′ of FIG. 5.

FIG. 7 is a sectional view taken along line C-C′ of FIG. 5.

FIG. 8 is a view for explaining an oil-water separator according to a first embodiment of the present application.

FIG. 9 is a view for explaining an oil-water separator according to a second embodiment of the present application.

FIG. 10 is a photograph for comparing spreading behavior and wettability of water and oil according to the presence or absence of a concave portion in an oil-water separator according to Experimental Example 3 of the present application.

FIG. 11 is a side and planar photograph of an oil-water separator according to Experimental Examples 1 to 4 of the present application.

FIG. 12(a) is a graph showing a length and a width of an oil-water separation hole of the oil-water separator manufactured according to Experimental Examples 1 to 4 of the present application, and FIG. 12(b) is a graph showing a porosity according to an angle of the oil-water separation hole of the oil-water separator manufactured according to Experimental Examples 1 to 4 of the present application.

FIG. 13(a) is a photograph showing an experimental process of an oil-water separation system manufactured according to Experimental Example 7 of the present application, and FIG. 13(b) is a photograph showing an experimental result of an oil-water separation system according to Experimental Example 7 of the present application.

FIG. 14(a) is a photograph showing behavior of water droplets when an oil film is present in the oil-water separator according to Experimental Example 7 of the present application, and FIG. 14(b) is a photograph for comparing contact angles of water droplets depending on the presence or absence of the oil film in an oil-water separator according to Experimental Example 7 of the present application.

FIG. 15 is a photograph obtained by capturing oil-water behavior according to Experimental Example 7 of the present application.

FIG. 16 is a graph showing a movement direction of oil-water according to Experimental Examples 1 to 7 of the present application.

FIG. 17 is a graph showing oil-water separation efficiency according to Experimental Examples 1 to 7 of the present application.

FIG. 18 is a graph showing oil-water separation efficiency of high-density oil.

FIG. 19(a) is a photograph of a wear test, and FIG. 19(b) is a graph showing oil-water separation efficiency according to a reuse test and the wear test.

FIG. 20(a) is a photograph of a moisture detection test of oil-water before ultrasonic treatment, FIG. 20(b) is a photograph of a moisture detection test of oil-water in an emulsion state after ultrasonic treatment, FIG. 20(c) is a photograph of a moisture detection test of oil separated from the oil-water in the emulsion state, and FIG. 20(d) is a photograph of a moisture detection test of water separated from the oil-water in the emulsion state.

### MODE FOR INVENTION

Hereinafter, preferred embodiments of the present invention will be described in detail with reference to the accompanying drawings. However, the present invention may be embodied in different forms and should not be construed as limited to the embodiments set forth herein. Rather, the embodiments are provided so that this disclosure will be thorough and complete, and will fully convey the scope of the present invention to those skilled in the art.

In addition, it will be also understood that although the terms first, second, third, etc. may be used herein to describe various elements, these elements should not be limited by these terms. These terms are only used to distinguish one element from another element. Thus, a first element in some embodiments may be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combination thereof, and they should not exclude the possibilities of combination or addition of one or more features, numbers, operations, elements, or a combination thereof. In addition, when detailed descriptions of related known functions or constitutions are considered to unnecessarily cloud the gist of the present invention in describing the present invention below, the detailed descriptions will not be included.

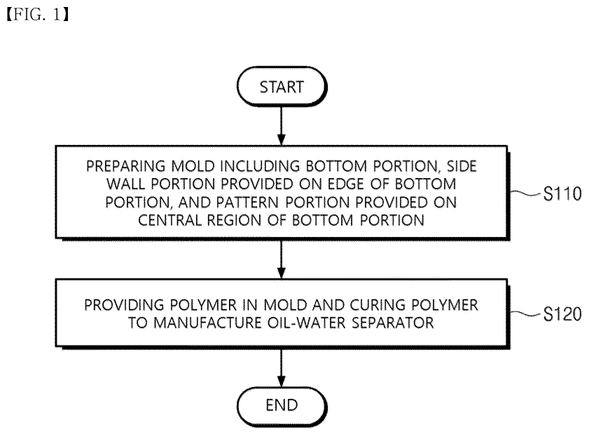

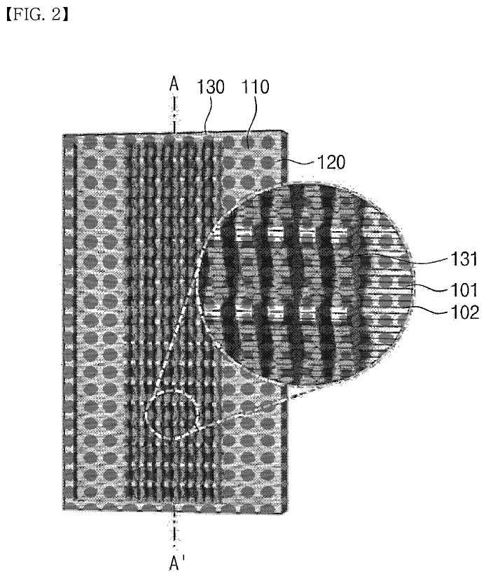

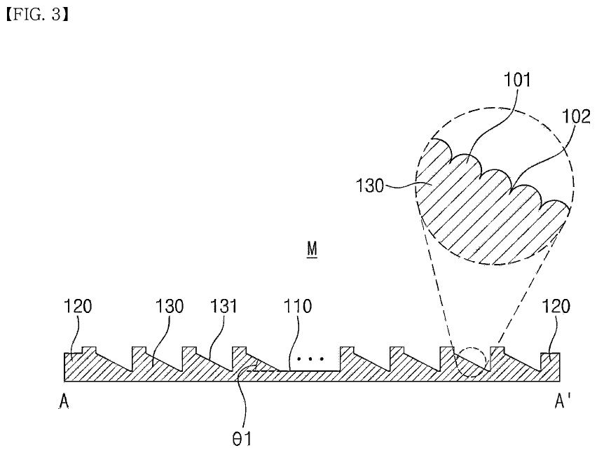

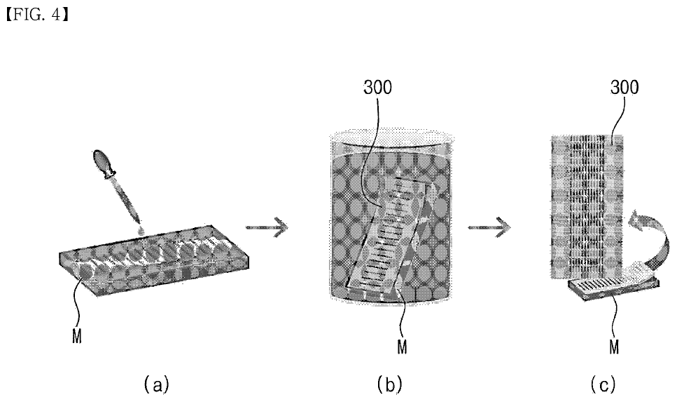

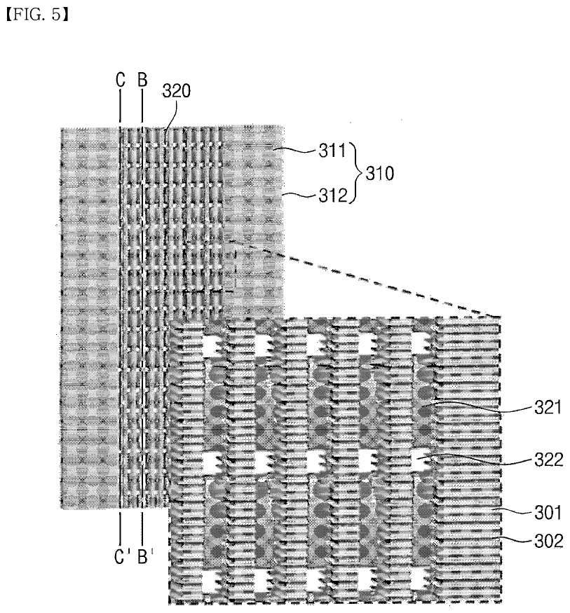

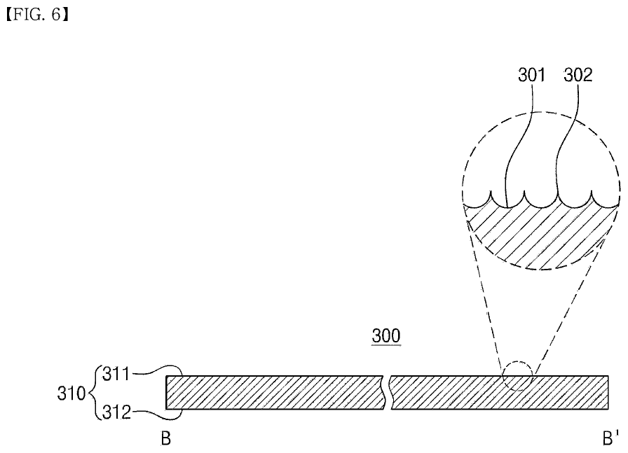

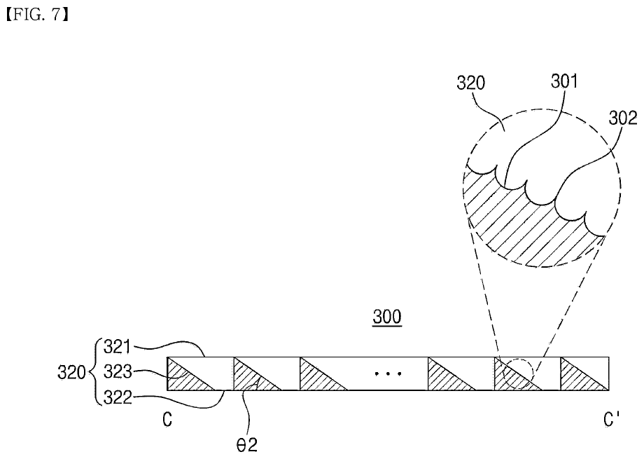

FIG. 1 is a flowchart for explaining a method for manufacturing an oil-water separator according to an embodiment of the present application, FIG. 2 is a view for explaining a mold used in the method for manufacturing an oil-water separator according to the embodiment of the present application, FIG. 3 is a sectional view taken along line A-A′ of FIG. 2, FIG. 4 is a view for explaining a process of providing a polymer and a process of separating the oil-water separator from the mold, FIG. 5 is a view for explaining the oil-water separator including an oil-water separation hole according to the embodiment of the present application, FIG. 6 is a sectional view taken along line B-B′ of FIG. 5, and FIG. 7 is a sectional view taken along line C-C′ of FIG. 5.

Referring to FIGS. 1 to 3, a mold including a bottom portion 110, a side wall portion 120 provided on an edge of the bottom portion 110, and a pattern portion 130 provided on a central region of the bottom portion 110 is prepared (S110).

A mold M may be a mold for manufacturing an oil-water separator to be described below. The mold M may be repeatedly used. Thus, the mold M may be variously designed according to the shape of the oil-water separator 300. Further, the mold M may be manufactured using a 3D printer employing fused filament fabrication. The mold M may be manufactured using polylactic acid, but is not limited thereto. The mold M may be manufactured by fused filament fabrication, and may include a plurality of first convex portions 101 and a plurality of first concave portions 102 provided on a surface thereof.

The bottom portion 110 may have a plate shape having a thickness.

The side wall portion 120 may be surrounded by an edge of the bottom portion 110 to have a predetermined height. The side wall portion 120 may be formed to prevent a polymer, which will be described below, from overflowing.

The pattern portion 130 may be formed on the central region of the bottom portion 110 on which the side wall portion 120 is not formed. A plurality of pattern portions 130 may be provided, in which the plurality of pattern portions 130 may be two-dimensionally aligned in rows and columns.

The pattern portion 130 may have a height higher than a height of the side wall portion 120 based on the bottom portion 110 in order to form an oil-water separation hole 320 of the oil-water separator 300 to be described later. The pattern portion 130 may have a shape with a cross-sectional area that becomes narrow in a direction away from the bottom portion 110. In addition, the pattern portion 130 may include a first inclined surface 131 inclined to the bottom portion 110.

The first inclined surface 131 may extend from the bottom portion 110 to a height of the side wall portion 120. In addition, the first inclined surface 131 may form an angle of θ1 with the bottom portion 110.

The angle θ1 of the first inclined surface 131 may be defined as an angle between the first inclined surface 131 and the bottom portion 110. The angle θ1 of the first inclined surface 131 may be controlled, for example, may be designed from 20° to 40°.

The first convex portions 101 may be spaced apart from each other in an extension direction of the first inclined surface 131 from an upper surface of the pattern portion 130 toward the bottom portion 110, and may be arranged in parallel to each other. As described above, the mold M may be manufactured by fused filament fabrication, and accordingly, the first convex portion 101 may be formed on the surface of the mold M. In other words, the plurality of first convex portions 101 may be arranged while being spaced from each other in a stacking direction of a filament. The first convex portion 101 may protrude in a direction away from the first inclined surface 131, and may include a round cross-section, for example.

The first concave portion 102 may be formed between the adjacent first convex portions 101. The first concave portions 102 may be spaced apart from each other in an extension direction of the first inclined surface 131 from the upper surface of the pattern portion 130 toward the bottom portion 110, and may be arranged in parallel to each other. As described above, the mold M may be manufactured by fused filament fabrication, and accordingly, the first concave portion 102 may be formed on the surface of the mold M. In other words, the plurality of first concave portions 102 may be arranged while being spaced from each other in a stacking direction of a filament. The first concave portion 102 may be recessed in a direction from the first inclined surface 131 toward the bottom portion 110, and may include a pointed cross-section, for example.

The first convex portion 101 and the first concave portion 102 may be formed the entire surface of the mold M. In other words, the first convex portion 101 and the first concave portion 102 may be formed on entire surfaces of the bottom portion 110, the side wall portion 120, and the pattern portion 130.

Next, referring to FIGS. 1 and 4, a polymer is provided in the mold M, and the polymer is cured to manufacture an oil-water separator (S120).

Referring to FIG. 4(a), the polymer is provided in the mold M. According to one embodiment, the polymer may fill the mold M to have a height substantially the same as the height of the side wall portion 120 of the mold M, or may fill the mold M to have a thickness less than a thickness of the side wall portion 120. As described above, the height (thickness) of the pattern portion 130 may be greater than the height (thickness) of the side wall portion 120, and accordingly, an upper region of the pattern portion 130 may protrude and be exposed on the polymer provided in the mold M. Therefore, a second opening 322 of the oil-water separator 310, which will be described below, may be formed.

As shown in FIG. 4(a), the polymer may be provided through a dropper in the mold M, but is not limited thereto.

According to one embodiment, the polymer may be a polymer compound having hydrophobicity and lipophilicity. For example, the polymer may be polydimethylsilioxane (PDMS), but is not limited thereto.

Alternatively, according to another embodiment, the polymer may be a polymer compound having hydrophilicity and oil-repellency. For example, the polymer may be polyurethane, but is not limited thereto.

Referring to FIGS. 4(b) and 4(c), the polymer provided in the mold M may be cured to manufacture the oil-water separator 300.

Although not shown, the polymer provided in the mold M may be cured through heat treatment, but is not limited thereto. The heat treatment conditions may vary depending on the material of the polymer.

The cured polymer may be treated with a special solution for separation from the mold M. The cured polymer may be treated with, for example, an acetone solution, but is not limited thereto. The special solution treatment conditions may vary depending on the material of the polymer.

The oil-water separator 300 may be manufactured by separating the cured polymer from the mold M. As described above, the oil-water separator 300 may include a surface profile corresponding to the shape of the mold M. Accordingly, the oil-water separator 300 may include a surface profile corresponding to the plurality of first convex portions 101 and the plurality of first concave portions 102 formed on the surface of the mold M. Further, the oil-water separator 300 may include a surface profile corresponding to the pattern portion 130 formed on the surface of the mold M, and the oil-water separator 300 may include a surface profile corresponding to the first inclined surface 131 of the pattern portion 130 formed on the surface of the mold M.

Referring to FIGS. 5 to 7, the oil-water separator 300 may include a base material 310 and an oil-water separation hole 320 formed through the base material 310. The oil-water separator 300 may include a plurality of second concave portions 301 and a plurality of second convex portions 302 corresponding to the plurality of convex portions 101 and the plurality of concave portions 102 formed on the surface of the mold M, respectively.

The base material 310 may include a first surface 311 and a second surface 312.

The first surface 311 is formed corresponding to the bottom portion 110 of the mold M, and may be one surface of the cured polymer which have make contact with the bottom portion 110 of the mold M. Accordingly, the first surface 311 may include the plurality of second concave portions 301 and the plurality of second convex portions 302 corresponding to the plurality of convex portions 101 and the plurality of concave portions 102 formed on the bottom portion 110 of the mold M, respectively. In other words, the first surface 311 of the base material 310 may have the second concave portion 301 corresponding to the first convex portion 101 of the mold M, and the first surface 311 of the base material 310 may have the second convex portion 302 corresponding to the first concave portion 102 of the mold M.

The second surface 312 is a surface facing the first surface 311, and may be a surface in parallel to the first surface 311. The second surface 312 may be the other surface of the cured polymer, which is a surface of the exposed polymer disposed in the mold M.

The oil-water separation hole 320 may be formed through the first surface 311 and the second surface 312 of the base material 310. The oil-water separation hole 320 may include a first opening 321 formed in the first surface 311 and a second opening 322 formed in the second surface 312. The oil-water separation hole 320 may include a second inclined surface 323 inclined to the first surface 311 as a side surface. In other words, the oil-water separation hole 320 may be formed through the base material 310 in an inclined direction. Further, the oil-water separation hole 320 is formed corresponding to the pattern portion 130 of the mold M, and the second inclined surface of the oil-water separation hole 320 may correspond to the first inclined surface 131 of the pattern portion 130. Accordingly, the oil-water separation hole 320 may include the plurality of second concave portions 301 and the plurality of second convex portions 302 corresponding to the plurality of convex portions 101 and the plurality of concave portions 102 formed on the pattern portion 130 of the mold M, respectively.

The first opening 321 may be formed corresponding to an outer circumferential surface where the bottom portion 110 and the pattern portion 130 of the mold M make contact with each other. Accordingly, the first opening 321 may have the shape and size corresponding to the outer circumferential surface where the bottom portion 110 makes contact with the pattern portion 130. In addition, the first opening 321 may be formed wider than the second opening 322.

The second opening 322 may be formed corresponding to an outer circumferential surface where the pattern portion 130 of the mold M makes contact with the upper surface of the polymer filled in the mold M. Accordingly, the second opening 322 may have the shape and size corresponding to the outer circumferential surface where the pattern portion 130 makes contact with the upper surface of the polymer. Therefore, the size of the second opening 322 may be controlled according to the thickness and/or height of the polymer provided in the mold M. For example, when the thickness and/or height of the polymer provided in the mold M is small and/or low, the size of the second opening 322 may be relatively large, and when the thickness and/or height of the polymer is large and/or high, the size of the second opening 322 may be relatively small.

The second inclined surface 323 may extend from the first surface 311 to the second surface 312. In addition, the second inclined surface 323 may form an angle of θ2 with the first surface 311. The second inclined surface 323 may be formed corresponding to the first inclined surface 131 of the mold M. The angle θ2 of the second inclined surface 323 may be defined as an angle between the second inclined surface 323 and the first surface 311. The angle θ2 of the second inclined surface 323 may be equal to the angle θ1 of the first inclined surface 131 of the mold M. Therefore, the angle θ2 of the second inclined surface 323 may be controlled as the angle θ1 of the first inclined surface 131 of the mold M is controlled. Further, the angle θ2 of the second inclined surface 323 may be controlled, for example, from 20° to 40°.

The second concave portion 301 may be formed corresponding to the first convex portion 101 of the mold M. The second concave portions 301 may be spaced apart from each other in an extension direction of the second inclined surface 323 from the first surface 311 toward the second surface 312, and may be arranged in parallel to each other. As described above, the second concave portion 301 may be recessed in a direction from the second inclined surface 323 to the second surface 312 corresponding to the first convex portion 101 of the mold M, and may include, for example, a round cross-section. The second concave portion 301 may be formed on the first surface 311 and the oil-water separation hole 320. Accordingly, the second concave portion 301 may have a function of guiding oil-water, which is supplied onto the oil-water separator 300, to the first surface 311 or the oil-water separation hole 320.

The second convex portion 302 may be formed corresponding to the first concave portion 102 of the mold M. The second convex portions 302 may be spaced apart from each other in an extension direction of the second inclined surface 323 from the first surface 311 toward the second surface 312, and may be arranged in parallel to each other. As described above, the second convex portion 302 may protrude in a direction away from the second inclined surface 323 corresponding to the first concave portion 102 of the mold M, and may include, for example, a pointed cross-section.

The second concave portion 301 and the second convex portion 302 may be formed on the surface of the oil-water separator 300 that is formed in contact with the surface of the mold M. In other words, the second concave portion 301 and the second convex portion 302 may be formed on the first surface 311 and the surface of the oil-water separation hole 320.

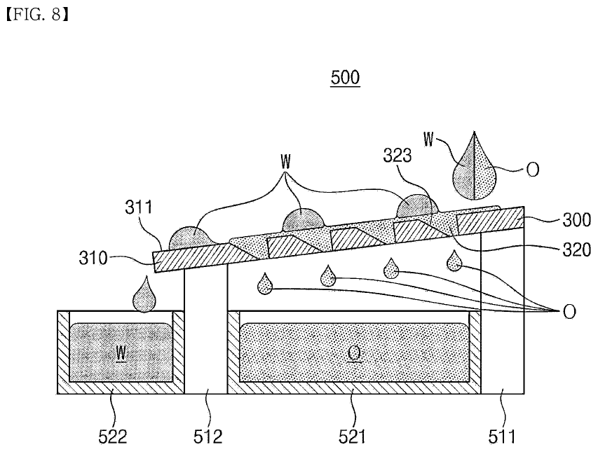

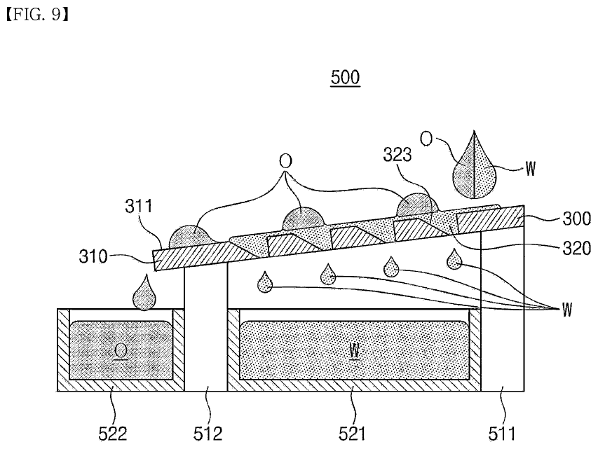

An oil-water separation system may be constructed using the oil-water separator described with reference to FIGS. 1 to 7. Hereinafter, an oil-water separation system according to embodiments of the present application will be described with reference to FIGS. 8 and 9.

FIG. 8 is a view for explaining an oil-water separator according to a first embodiment of the present application, and FIG. 9 is a view for explaining an oil-water separator according to a second embodiment of the present application.

Referring to FIGS. 8 and 9, an oil-water separation system 500 may include: a support module 510 for supporting the oil-water separator 300 to be inclined; and a storage container 520 for accommodating separated water W and oil O. In addition, the oil-water separation system 500 may include the inclined oil-water separator 300.

The support module 510 may include a first support 511 for supporting one side of the inclined oil-water separator 300 and a second support 512 for supporting the other side of the inclined oil-water separator 300. The support module 510 may control an angle in order to add an inclination to the oil-water separator 300. The support module 510 may control the angle by adjusting the length and interval of each of the first support 511 and the second support 512. An angle (not shown) of the supporting module 510 is defined as an angle between the inclined first surface 311 of the oil-water separator 300 and the ground. The angle (not shown) of the support module 510 may be controlled to be larger as the first support 511 is longer than the second support 512. In addition, the angle (not shown) of the support module 510 may be controlled to be smaller as the interval between the first support 511 and the second support 512 is large. The angle (not shown) of the support module 510 may be controlled, for example, from 10° to 30°.

The first support 511 may support one side of the inclined oil-water separator 300 into which oil-water is introduced. The first support 511 may adjust the length as needed. Accordingly, the first support 511 may be formed to be longer than the second support 512 such that the oil-water may slide using gravity.

The second support 512 may support the other side of the inclined oil-water separator 300 through which the oil-water is discharged after being separated from each other. The second support 512 may adjust the length as needed. Therefore, the second opening 512 may be formed shorter than the first support 511.

In addition, the length and interval of each of the first support 511 and the second support 512 may be adjusted. The angle (not shown) of the support module 510 may be adjusted by adjusting the length and interval of each of the first support 511 and the second support 512.

The storage container 520 may accommodate the separated water W or oil O. The storage container 520 may include a first container 521 and a second container 522 disposed between the first support 511 and the second support 512, and a second container 522 disposed on a side of the second support.

The first container 521 may accommodate water W or oil O separated from each other while passing through the oil-water separation hole 320 of the inclined oil-water separator 300.

The second container 522 may accommodate water W or oil O flowing down along the first surface 311 of the inclined oil-water separator 300.

The inclined oil-water separator 300 may include the inclined first surface 311 and the inclined oil-water separation hole 320.

The inclined first surface 311 may have an inclination from the ground as described above. The inclined first surface 311 may allow one of the separated water W or oil O to slide.

The inclined oil-water separation hole 320 may allow the other of the separated water W or oil O to be discharged. The oil-water separation hole 320 may include the inclined second inclined surface 323 inclined to the first surface 311.

The inclined second surface 323 may allow one of water W or oil O separated from the oil-water to slide. In addition, the inclined second inclined surface 323 may be formed in a direction intersecting the first surface 311.

According to one embodiment, the oil-water separator 300 may have lipophilicity and hydrophobicity. Specifically, the oil-water separator 300 may have lipophilicity and hydrophobicity when the polymer has lipophilicity and hydrophobicity. Alternatively, the oil-water separator 300 may have lipophilicity and hydrophobicity when lipophilicity and hydrophobicity treatments are performed on the surface of the polymer. Accordingly, as shown in FIG. 8, water W may flow along the inclined first surface 311, and oil O may flow along the inclined second inclined surface 323.

As a result, the separated oil O may flow down along the inclined second inclined surface 323 to be accommodated in the first container 521, and the separated water W may flow down along the first surface 311 to be accommodated in the second container 522.

According to another embodiment, the oil-water separator 300 may have hydrophilicity and water-repellency. Specifically, the oil-water separator 300 may have hydrophilicity and water-repellency when the polymer has hydrophilicity and water-repellency. Alternatively, the oil-water separator 300 may have hydrophilicity and water-repellency when hydrophilicity and water-repellency treatments are performed on the surface of the polymer. Accordingly, as shown in FIG. 9, oil O may flow along the inclined first surface 311, and water W may flow along the inclined second inclined surface 323.

As a result, the separated oil O may flow down along the first surface 311 to be accommodated in the second container 522, and the separated water W may flow down along the second surface 323 to be accommodated in the first container 521.

Hereinafter, specific experimental examples and characteristic evaluation results of the oil-water separator and the oil-water separation system according to the experimental examples of the present application will be described.

### Manufacture of Oil-Water Separator According to Experimental Example 1

A mold was designed to have an angle of 10° (corresponding to the angle θ1 of the first inclined surface described with reference to FIGS. 1 to 9) of the pattern portion using 3D modeling software (CATIA V5), and was printed with a polylactic acid (PLA) filament (¥1.75 mm) by using a 3D printer (3DWOX 2X, Sindoh) employing fused filament fabrication. The mold was also output under conditions of a layer height of 0.05 mm, a printing rate of 40 mm/s, an extrusion temperature of 220° C., an internal temperature of 40° C., and a nozzle diameter of 0.4 mm.

Accordingly, the mold output filament fabrication using 3D printing includes a plurality of convex portions (corresponding to the first convex portions described with reference to FIGS. 1 to 9) having a size of 50 μm, which are formed by a patterned by staircase effect (PSE).

A mixture of PDMS (Sylgard 184, Dow Corning Inc.) (PDMS:curing agent=10:1) was poured into the mold printed by a 3D printer to remove gas in a vacuum chamber for 1 hour, and then cured in an oven at 60° C. for 6 hours. When the cured PDMS mixture (oil-water separator) was separated from the mold after the mold was immersed in acetone for 2 hours, an oil-water separator (Mesh10A) including a plurality of concave portions (corresponding to the second concave portions described with reference to FIGS. 1 to 9) and having an angle of an oil-water separation hole (corresponding to the angle θ2 of the second inclined surface described with reference to FIGS. 1 to 9) of 10° was prepared.

### Manufacture of Oil-Water Separator According to Experimental Example 2

An oil-water separator was manufactured by the method according to Experimental Example 1, and an oil-water separator (Mesh20A) including a plurality of concave portions and having an angle of oil-water separation hole of 20° was manufactured by controlling an angle of the pattern portion to 20°.

### Manufacture of Oil-Water Separator According to Experimental Example 3

An oil-water separator was manufactured by the method according to Experimental Example 1, and an oil-water separator (Mesh30A) including a plurality of concave portions and having an angle of oil-water separation hole angle of 30° was manufactured by controlling an angle of the pattern portion to 30°.

### Manufacture of Oil-Water Separator According to Experimental Example 4

An oil-water separator was manufactured by the method according to Experimental Example 1, and an oil-water separator (Mesh40A) including a plurality of concave portions and having an angle of oil-water separation hole angle of 40° was manufactured by controlling an angle of the pattern portion to 40°.

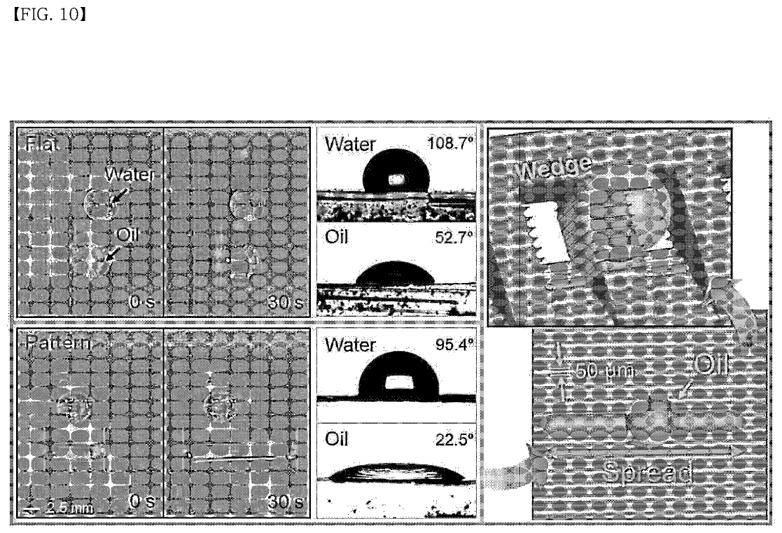

FIG. 10 is a photograph for comparing spreading behavior and wettability of water and oil according to the presence or absence of a concave portion in an oil-water separator according to Experimental Example 3 of the present application.

Referring to FIG. 10, it was confirmed that water and oil in the oil-water separator have different spreading behaviors depending on the presence or absence of the concave portion.

When water and oil fell at the same time in an oil-water separator (Flat) that did not include the concave portion, it can be confirmed that water droplets do not spread and show stable behavior, and oil droplets slowly spread for 30 seconds. In addition, after 30 seconds of dropping the water droplets and the oil droplets, a contact angle of the water droplet was measured to be 108.7±1.0°, and a contact angle of the oil droplet was measured to be 52.7±1.5°.

When the water and oil droplets fell at the same time on the oil-water separator (Pattern) including the concave portion, it can be confirmed that the water droplets show relatively stable behavior even after 30 seconds elapsed, but the oil droplets start to spread immediately after falling and gradually spread for 30 seconds. In addition, after 30 seconds of dropping the water droplets and the oil droplets, a contact angle of the water droplet was measured to be 95.4±1.0°, and a contact angle of the oil droplet was measured to be 22.5±1.6°.

It was confirmed that the oil spreading was improved through a capillary effect of the concave portion having a size of 50 μm, which is formed by a patterned by staircase effect (PSE) using 3D printing.

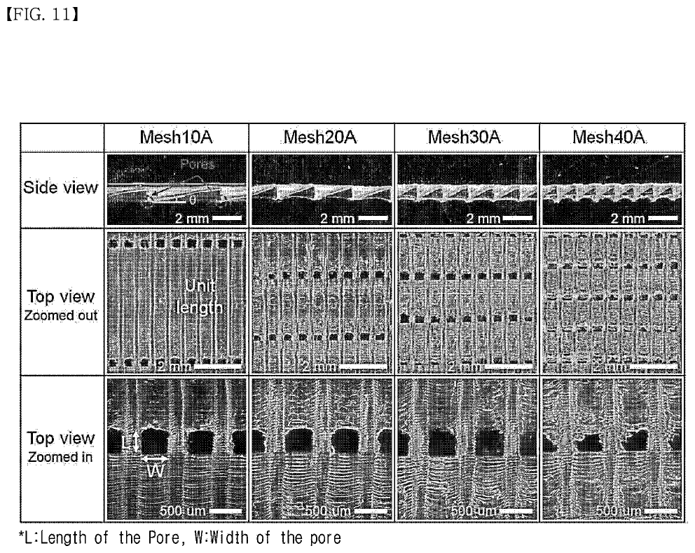

FIG. 11 is a side and planar photograph of an oil-water separator according to Experimental Examples 1 to 4 of the present application.

Referring to FIG. 11, the side surface and the upper surface of the oil-water separator, which was manufactured according to Experimental Examples 1 to 4 of the present application, were captured. In FIG. 11, Mesh10A is an oil-water separator in which the angle of the oil-water separation hole is 10°, Mesh20A is an oil-water separator in which the angle of the oil-water separation hole is 20°, Mesh30A is an oil-water separator in which the angle of the oil-water separation hole is 30°, and Mesh40A is an oil-water separator in which the angle of the oil-water separation hole is 10°.

when viewed from a side, it can be confirmed that the oil-water separation hole may be confirmed through a circle indicated by a dotted line, a unit length may be set based on Mesh10A, and as the angle of the oil-water separation hole increases, the number of oil-water separation holes per unit area increases, so that a distance between the oil-water separation holes decreases.

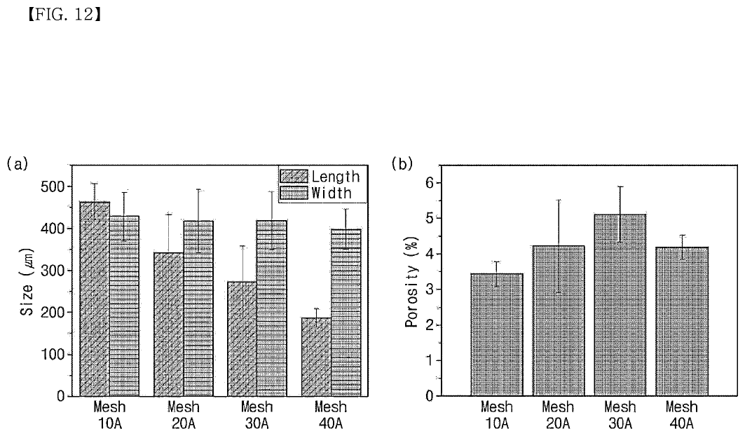

FIG. 12(a) is a graph showing a length and a width of an oil-water separation hole of the oil-water separator manufactured according to Experimental Examples 1 to 4 of the present application, and FIG. 12(b) is a graph showing a porosity according to an angle of the oil-water separation hole of the oil-water separator manufactured according to Experimental Examples 1 to 4 of the present application.

Referring to FIG. 12(a), it was confirmed that as the angle of the oil-water separation hole increased from 10° to 40° (Mesh10A to Mesh40), the length of the oil-water separation hole decreased, whereas the width of the oil-water separation hole was hardly changed.

This is because the interval between the oil-water separation holes decreases as the angle of the second inclined surface increases, and accordingly, it can be confirmed that the oil-water separation hole of Mesh40A (oil-water separator in which the angle of the oil-water separation hole is) 40° is distorted.

Therefore, it can be seen from the planar photograph of Mesh40A (oil-water separator where the angle of the second inclined surface is) 40° that when the angle of the second inclined surface is greater than a predetermined angle, the clarity of the oil-water separation hole may be deteriorated.

Referring to FIG. 12(b), it can be seen that as the angle of the second inclined surface increases from 10° to 30°, the porosity (ratio of the porosity to the total volume, %) increases, but when the angle of the second inclined surface is 40°, the porosity decreases non-linearly. In addition, the porosity is calculated as follows.

$$Porosity = \frac{Area of the pores}{Unit area of the membrane}$$

### Oil-Water Separation System According to Experimental Example 5

A system (Bed10A), in which the oil-water separator according to Experimental Examples 1 to 4 is used as an oil-water separator, the support module is controlled to have a slope of 10°, and after the oil-water separator is placed on the support module, oil-water is separated using gravity, is formed.

Deionized (DI) water and paraffin oil were used in the experiment, and the DI water was dyed blue for visualization and an oil film was formed with 0.18 g of oil in the oil-water separator before the oil-water separation experiment.

The same amount (1000 ul) of water and oil were injected into the water supply tube and the oil supply tube at a speed of 200 um/s for 5 minutes by using the same syringe pump (PHD ULTRA, Harvard Apparatus Ltd.).

The oil separated through the oil-water separation system was accommodated in the storage container, and the mass (M) of the oil accommodated in the storage container was measured two minutes after the injection was completed in consideration of the time for the oil to flow down, and separation efficiency was calculated as follows using the measured mass (M).

$$Separation efficiency ( n ) = \frac{mass of the separated oil ( M )}{mass of the oil ( {M}_{0} )} \times 100 \%$$

### Oil-Water Separation System According to Experimental Example 6

An oil-water separation system is formed by the method according to Experimental Example 5, but a slope of the support module is controlled to 20° to form an oil-water separation system Bed20A.

### Oil-Water Separation System According to Experimental Example 7

An oil-water separation system is formed by the method according to Experimental Example 5, but a slope of the support module is controlled to 30° to form an oil-water separation system Bed30A.

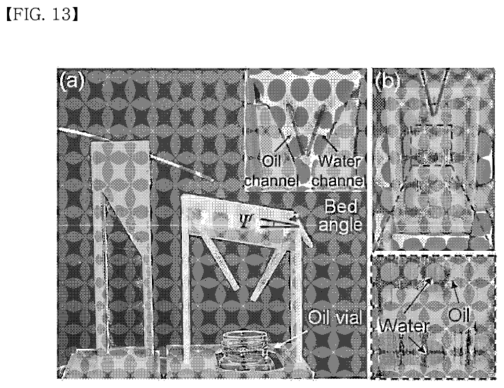

FIG. 13(a) is a photograph showing an experimental process of an oil-water separation manufactured according to Experimental Example 7 of the present application, and FIG. 13(b) is a photograph showing an experimental result of an oil-water separation system according to Experimental Example 7 of the present application.

Referring to FIGS. 13(a) and 13(b), it was confirmed that when water and oil were dropped in the oil-water separation system at the same time, the oil passed through the oil-water separation hole and was accommodated in the container, and the water flowed down along the surface of the oil-water separator.

In addition, reliability was improved by performing five consecutive experiments on the oil-water separation system under the same experimental conditions for each type, and the separation efficiency for each oil-water separation system was compared by measuring the amount of oil injected before the experiment and the amount of oil contained in the container.

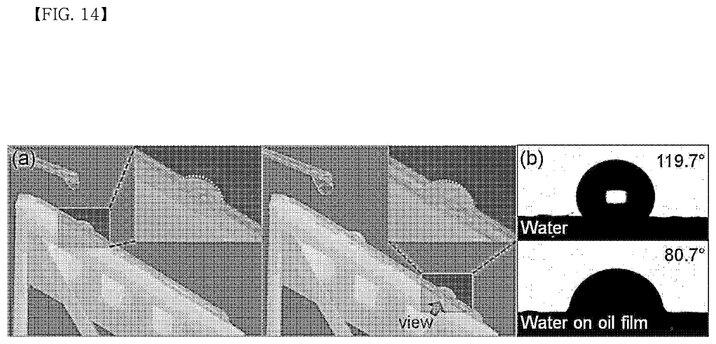

FIG. 14(a) is a photograph showing behavior of water droplets when an oil film is present in the oil-water separator according to Experimental Example 7 of the present application, and FIG. 14(b) is a photograph for comparing contact angles of water droplets depending on the presence and absence of the oil film in an oil-water separator according to Experimental Example 7 of the present application.

Referring to FIG. 14(a), it was confirmed that when an oil film was formed in the oil-water separator, the wettability of water increased as compared to the case where the oil film was not formed.

Referring to FIG. 14(b), when the oil-water separator had no oil film formed on the surface thereof, the contact angle was 119.7°, whereas when the oil film was formed, the contact angle was reduced to 80.7°. It was confirmed that since the oil-water is separated due to flowing down, rather than rolling down of water drops, the presence or absence of the oil film did not affect the separation efficiency.

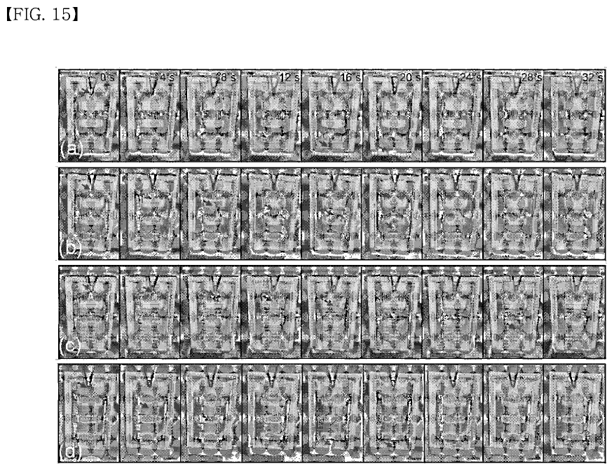

FIG. 15 is a photograph obtained by capturing oil-water behavior according to Experimental Example 7 of the present application.

Referring to FIG. 15, FIG. 15(a) shows oil-water behavior of Mesh10A, FIG. 15(b) shows oil-water behavior of Mesh20A, FIG. 15(c) shows oil-water behavior of Mesh30A, and FIG. 15(b) shows oil-water behavior of Mesh40A.

The oil-water separation system was fixed using Bed20A, the oil-water separator in the oil-water separation system was changed to Mesh10A, Mesh20A, Mesh30A, and Mesh40A, respectively, and the behavior of the oil-water was confirmed by capturing an image every 4 seconds until the water and oil were dropped at the same time and the water completely slid down.

Referring to FIG. 15(a), it was confirmed that in the case of Mesh10A, the water droplets completely slid in 22 seconds, which is the shortest time, referring to FIG. 15(b), in the case of Mesh20A, the water droplets completely slid in 23 seconds, referring to FIG. 15(c), in the case of Mesh30A, the water droplets completely slid in 29 seconds, and referring to FIG. 15(d), in the case of Mesh40A, the water droplets completely slid out in 22 seconds.

It was confirmed through the planar photograph of Mesh40A that the clarity of the oil-water separation hole was deteriorated, and in the Mesh40A, the interval between the oil-water separation holes decreased because the angle of the oil-water separation hole is a predetermined angle or greater, so that it was confirmed that the oil-water behaves non-linearly.

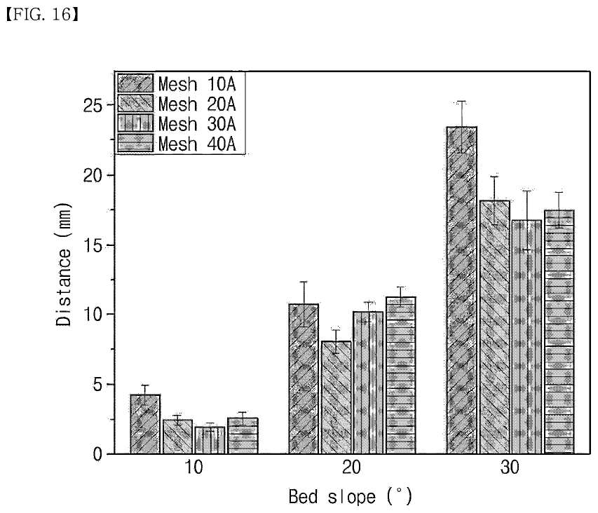

FIG. 16 is a graph showing a movement direction of oil-water according to Experimental Examples 1 to 7 of the present application.

Referring to FIG. 16, a movement distance of the oil-water according to the slope changes (Bed10A, Bed20A, and Bed30A) of the support module may be confirmed. It can be confirmed that as the slope of the support module increases, the movement distance of the oil-water increases steeply. This means that when the slope of the support module is large, the oil-water is separated quickly, but this may not mean that the separation efficiency is high.

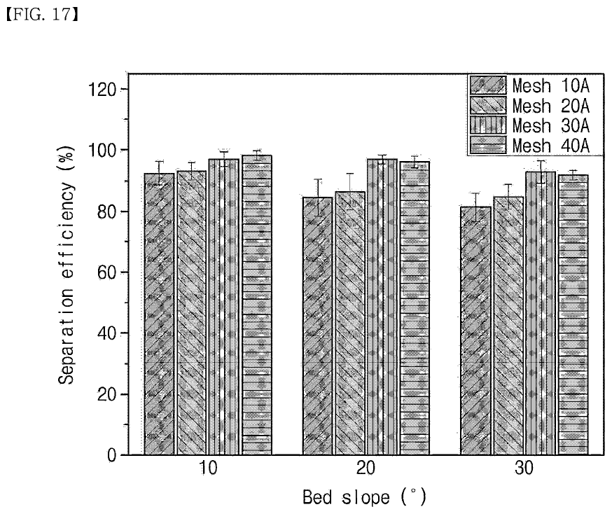

FIG. 17 is a graph showing oil-water separation efficiency according to Experimental Examples 1 to 7 of the present application.

Referring to FIG. 17, it was confirmed that, when the slope of the support module was 10°, Mesh40A had the average separation efficiency of 98.1%, Mesh30A had the average separation efficiency of 96.9%, Mesh20A had the average separation efficiency of 93%, and Mesh10A had the average separation efficiency of 92.3%, and as the angle of the oil-water separation hole increased, high separation efficiency was exhibited.

It was confirmed that when the slope of the support module was 20°, Mesh30A had the average separation efficiency of 96.8%.

In addition, it was confirmed that when the slope of the support module was 30°, Mesh30A had the average separation efficiency of 92.8%, and Mesh40A had the average separation efficiency of 91.9%.

However, it was confirmed that the average separation efficiency of Mesh10A and Mesh20A was 85% or less when the slopes of the support modules were 10°, 20°, and 30°.

As a result, it was confirmed that Mesh30A had stable separation efficiency regardless of the slope of the support module.

That is, through the experiments of FIGS. 15 and 16, it was confirmed that the longer the water droplets completely slide down (Mesh30A, 29 sec), the more stable separation efficiency was obtained.

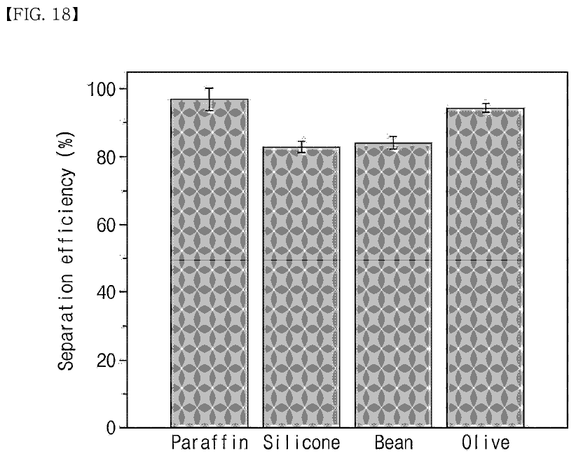

FIG. 18 is a graph showing oil-water separation efficiency of high-density oil.

Referring to FIG. 18, an experiment for confirming the oil-water separation efficiency of high-density oil (olive oil, silicone oil, and soybean oil) was additionally performed under conditions of the oil-water separator according to Experimental Example 3 and the oil-water separation system according to Experimental Example 5.

In case of Mesh30A and Bed10A, as a result of measuring the separation efficiency of oil-water in which water and the high-density oil were mixed, it was confirmed that the separation efficiency of oil-water in which the paraffin oil and the olive oil were mixed was high at 90% or more, and the separation efficiency of oil-water in which the silicone oil and the soybean oil were mixed was 80% or more.

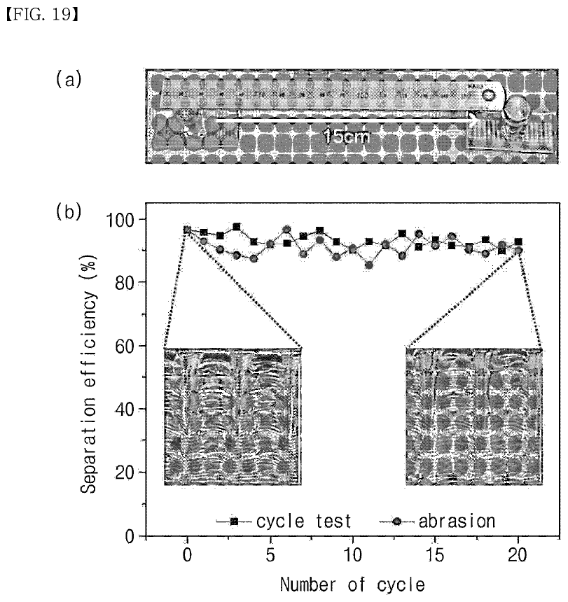

FIG. 19(a) is a photograph of a wear test, and FIG. 19(b) is a graph showing oil-water separation efficiency according to a reuse test and the wear test.

Referring to FIGS. 19(a) and (b), in the conditions of the oil-water separator according to Experimental Example 3 and the oil-water separation system according to Experimental Example 5, periodic experiments and wear experiments were additionally conducted to confirm the possibility of reuse of the oil-water separator, the periodic experiments were repeatedly conducted with respect to 1 cycle of washing after measuring the separation efficiency of the oil-water, and the wear experiments were conducted by moving the oil-water separator 4 times per cycle by 15 cm by changing the position of the weight (20 g) of 20 g after placing the oil-water separator on the sandpaper (P600).

It can be confirmed that there is no significant change in the separation efficiency according to the repetition of the periodic experiment and the wear experiment of the oil-water separator. Accordingly, it was confirmed that the oil-water separator manufactured according to the experimental example of the present application is reusable because the oil-water separator is resistant to repeated washing and wear and has stable separation efficiency.

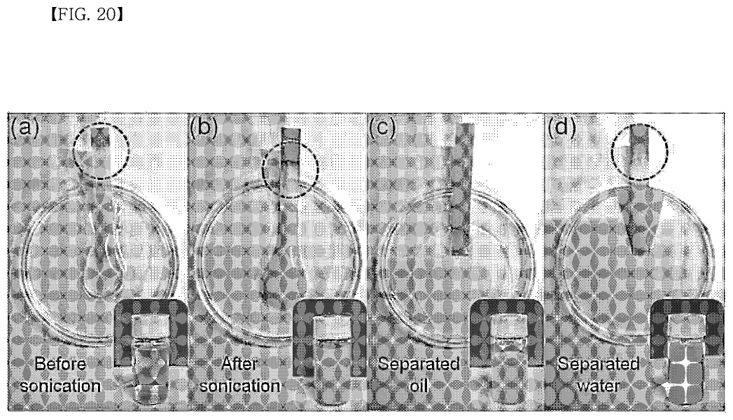

FIG. 20(a) is a photograph of a moisture detection test of oil-water before ultrasonic treatment, FIG. 20(b) is a photograph of a moisture detection test of oil-water in an emulsion state after ultrasonic treatment, FIG. 20(c) is a photograph of a moisture detection test of oil separated from the oil-water in the emulsion state, and FIG. 20(d) is a photograph of a moisture detection test of water separated from the oil-water in the emulsion state.

Referring to FIG. 20, in order to confirm the separation performance of the oil-water separator for the oil-water in an emulsion state under the conditions of the oil-water separator according to Experimental Example 3 and the oil-water separation system according to Experimental Example 5, an experiment for separating the mixed oil-water was conducted by using a cobalt chloride paper and an ultrasonic cleaner (wuca03H, Daihan Scientific Co.) that measure a moisture content according to the change in color.

Referring to FIG. 20(c), it can be seen that water is not included in the oil separated from the oil-water in the emulsion state, whereas referring to FIGS. 20(a), 20(b), and 20(d), water is included in the oil separated from the oil-water in the emulsion state. It was confirmed that the efficiency of oil-water separation in an emulsion state was about 60%.

Although the present invention has been described in detail using the preferred embodiments and various experimental examples, the scope of the present invention is not to be limited specific embodiments, and should be constructed by the appended claims. In addition, it is to be understood that those skilled in the art can substitute, change or modify the embodiments in various forms without departing from the scope and spirit of the present invention.

### INDUSTRIAL APPLICABILITY

The technical idea according to the embodiments of the present application may be used as an oil-water separator.

1. A method for manufacturing an oil-water separator, the method comprising:
preparing a mold including a bottom portion, a side wall portion provided on an edge of the bottom portion, and a pattern portion provide on a central region of the bottom portion; and
providing a polymer in the mold and curing the polymer to manufacture the oil-water separator,
wherein the pattern portion has a height higher than a height of the side wall portion based on the bottom portion, and has a cross-sectional area that becomes narrow in a direction away from the bottom portion.

2. The method of claim 1, wherein the mold includes:
a plurality of first convex portions provided on surfaces of the bottom portion, the side wall portion, and the pattern portion, and being parallel to each other; and
a plurality of first concave portions defined between adjacent first convex portions.

3. The method of claim 2, wherein the mold is manufactured using a 3D printing process employing fused filament fabrication.

4. The method of claim 3, wherein the pattern portion includes a first inclined surface inclined to the bottom portion, and the plurality of first convex portions are spaced apart from each other in an extension direction of the first inclined surface.

5. The method of claim 1, further comprising hydrophilizing a surface of the oil-water separator after the manufacturing of the oil-water separator.

6. The method of claim 4, wherein the first inclined surface of the pattern portion forms an angle of 20° to 40° with respect to the bottom portion.

7. An oil-water separator comprising:
a base material including a first surface and a second surface facing the first surface; and
a plurality of oil-water separation holes formed through the base material,
wherein a first opening of the oil-water separation hole formed in the first surface is larger than a second opening of the oil-water separation hole formed in the second surface.

8. The oil-water separator of claim 7, wherein the oil-water separator has hydrophobicity and lipophilicity, and
oil in oil-water supplied to the oil-water separator passes through the oil-water separation hole, and water in the oil-water flows down along the first surface.

9. The oil-water separator of claim 7, wherein the oil-water separator has hydrophilicity and oil-repellency, and
water in oil-water supplied to the oil-water separator passes through the oil-water separation hole, and oil in the oil-water flows down along the first surface.

10. The oil-water separator of claim 7, wherein the oil-water separator includes:
a plurality of second concave portions provided on surfaces of the base material and the oil-water separation hole, and being parallel to each other; and
a plurality of second convex portions defined by adjacent second concave portions, and
oil-water supplied onto the oil-water separator is guided to the oil-water separation hole along the second concave portion, and one of water and oil is discharged through the oil-water separation hole.

11. The oil-water separator of claim 10, wherein the oil-water separation hole includes a second inclined surface inclined to the first surface as a side wall, and the plurality of second concave portions are spaced apart from each other in an extension direction of the second inclined surface.

12. An oil-water separation system including a support module configured to support the oil-water separator of claim 7 such that the oil-water separator is inclined, and a storage container configured to accommodate separated water and oil,
wherein the support module includes:
a first support configured to support one side of the oil-water separator into which oil-water is introduced; and
a second support having a length shorter than a length of the first support, and configured to support the other side of the oil-water separator through which the oil-water is discharged after being separated from each other, and
the storage container includes:
a first container disposed between the first support and the second support to accommodate one of water and oil; and
a second container disposed on a side of the second support to accommodate the other of water and oil.

13. The oil-water separation system of claim 12, wherein the oil-water separation hole includes a second inclined surface inclined to the first surface as a side wall,
the second inclined surface is formed in a direction opposite to a flowing direction of the oil-water, so that one of water and oil flows along the second inclined surface, and
the other of water and oil flows from the first support toward the second support along the first surface of the oil-water separator where the oil-water separation hole is not formed.
